(19) United States
(12) Patent Application Publication
(10) Pub. No.: US 2021/0195671 A1
(43) Pub. Date: Jun. 24, 2021

(54) Control Method for Displaying Service Identifier in Electronic Device, Electronic Device, and Storage

(71) Applicant: GUANGDONG OPPO MOBILE TELECOMMUNICATIONS CORP., LTD., Dongguan (CN)

(72) Inventors: Tao Zhang, Dongguan (CN); Yang Xia, Dongguan (CN); Kai Tang, Dongguan (CN)

(21) Appl. No.: 17/192,047

(22) Filed: Mar. 4, 2021

Related U.S. Application Data
(63) Continuation of application No. PCT/CN2019/103372, filed on Aug. 29, 2019.

(30) Foreign Application Priority Data
Sep. 4, 2018 (CN) 201811027392.5

(51) Int. Cl. H04W 76/16; H04W 76/11; H04W 72/04; H04W 72/08

(52) U.S. Cl. CPC H04W 76/16; H04W 76/11; H04W 72/087; H04W 72/0493; H04W 72/042

(57) ABSTRACT

A method for controlling display of a service identifier includes: in response to a service scenario being detected as a downlink data service scenario, an electronic device transmitting, to a first network device a request to query resource allocation information; receiving the resource allocation information transmitted by the first network device; and determining, according to the resource allocation information, a service identifier corresponding to the electronic device, and displaying the service identifier. The invention enables the actual communication state of an electronic device to be accurately intuitively and comprehensively displayed, thereby enhancing comprehensiveness and accuracy of information displayed by an electronic device.

### CROSS-REFERENCE TO RELATED APPLICATION(S)

The present application is a continuation-application of International (PCT) Patent Application No. PCT/CN2019/103372 filed on Aug. 29, 2019, which claims priority of Chinese Patent Application No. 201811027392.5, in the title of “Method for Controlling Display of Service Identifier and Related Product,” filed on Sep. 4, 2018, the entire contents of both of which are hereby incorporated by reference.

### TECHNICAL FIELD

The present disclosure relates to the field of electronic devices, and in particular to a control method for displaying a service identifier in an electronic device, an electronic device, and a non-transitory computer-readable storage medium.

### BACKGROUND

With the development of the mobile communication technology, users have an increasing demand for communicating using electronic devices such as mobile phones. In the art, while electronic devices are transmitting data, data plane services may be transmitted through a data network, such as the 4^{th} Generation (4G) long-term evolution (LTE) network, whereas telephone service data may still be transmitted through a traditional circuit domain network, such as the 2^{nd} Generation (2G) and the 3^{rd} Generation (3G) networks. The electronic device may display a service identifier on a relevant interface of a local end to indicate a current communication status of the electronic device. With respect to an IMS call service of an IP multimedia subsystem, a display scheme for a service identifier of a downlink data service in a 5G NSA communication system is still not available in the art.

### SUMMARY

According to a first aspect, embodiments of the present disclosure provide a control method for displaying a service identifier in an electronic device. The electronic device supports a dual connection mode in which the electronic device establishes a first communication connection with a first network device and establishes a second communication connection with a second network device. The method may include following operations.

The electronic device may send a query request for resource allocation information to the first network device, in response to the electronic device being detected to be in a downlink data service scenario.

The electronic device may receive the resource allocation information from the first network device.

The electronic device may determine and display a target service identifier of the electronic device based on the resource allocation information.

According to a second aspect, embodiments of the present disclosure provide an electronic device, supporting a dual connection mode in which the electronic device establishes a first communication connection with a first network device and establishes a second communication connection with a second network device. The electronic device includes a processor, a non-transitory memory, a communication interface, and one or more programs, wherein the one or more programs are stored in the non-transitory memory and are configured to be executed by the processor, and the programs include an instruction for performing operations of: sending a query request for resource allocation information to the first network device, in response to the electronic device being detected to be in a downlink data service scenario; receiving the resource allocation information from the first network device; and determining and displaying a target service identifier of the electronic device based on the resource allocation information.

According to a third aspect, embodiments of the present disclosure provide a non-transitory computer-readable storage medium, configured to store a computer program for exchanging electronic data. The computer program enables a processor of an electronic device to execute a part or all of the operations of any method of the first aspect of the present disclosure.

### BRIEF DESCRIPTION OF DRAWINGS

In order to clearly describe technical solutions in the embodiments of the present application or in the prior art, accompanying drawings for the description of the embodiments or the prior art will be introduced in brief. Obviously, the drawings in the following description are only some embodiments of the present disclosure. Any ordinary skilled in the art may obtain other drawings based on the following drawings without creative work.

FIG. 1 is an exemplary architecture of a wireless communication system according to an embodiment of the present disclosure.

FIG. 2A is a flowchart of a control method for displaying a service identifier in an electronic device according to an embodiment of the present disclosure.

FIG. 2B is a presentative view of displaying a first service identifier on a display interface according to an embodiment of the present disclosure.

FIG. 2C is a presentative view of displaying a second service identifier on a display interface according to an embodiment of the present disclosure.

FIG. 3 is a flowchart of another control method for displaying a service identifier in an electronic device according to an embodiment of the present disclosure.

FIG. 4 is a flowchart of another control method for displaying a service identifier in an electronic device according to an embodiment of the present disclosure.

FIG. 5 is structural schematic view of an electronic device according to an embodiment of the present disclosure.

FIG. 6 is a block diagram of functional units of an apparatus for controlling display of a service identifier according to an embodiment of the present disclosure.

### DETAILED DESCRIPTION

In order to enable the skilled person in the art to better understand technical solutions of the present disclosure, the technical solutions of the embodiments of the present disclosure will be described clearly and completely in combination with the accompanying drawings. Obviously, the described embodiments are only a part of, but not all of, the embodiments of the present disclosure. Based on the embodiments in the present disclosure, all other embodiments may be obtained by an ordinary skilled person in the art without creative work, and shall fall within the scope of the present disclosure.

Terms “first”, “second”, and the like in the description and claims of the present disclosure and in the above-mentioned drawings are used to distinguish different objects, but not to describe a specific order. Furthermore, terms “including”, “having” and any variations thereof are intended to suggest non-exclusive inclusion. For example, a process, a method, a system, a product, or a device including a series of operations or units are not limited to the listed operations or units, but alternatively also includes operations or units that are not listed, or also includes other operations or units inherently included in the process, in the method, in the product or in the device.

An “embodiment” mentioned in the present disclosure may refer to a particular feature, a structure, or a property described in connection with the embodiment being included in at least one embodiment of the present disclosure. The term occurring in various sections of the specification may not refer to a same embodiment, or an embodiment that is independent from, alternative to, or mutually exclusive with other embodiments. Skilled person in the art shall understand that the embodiments described herein may be combined with other embodiments.

The electronic device involved in the embodiments of the present disclosure may be an electronic device capable of transmitting data. The electronic device may include various devices with wireless communication functions, such as a handheld device, a vehicle-mounted device, a wearable device, a computing device, or a wireless modem, and user equipment (UE) in various forms, a mobile station (MS), a terminal device, and so on. The embodiments of the present disclosure will be described in detail below.

The technical solutions of the embodiments of the present disclosure may be applied to various communication systems. The communication systems may include, but are not limited to, a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, a LTE Frequency Division Duplex (FDD) system, a LTE Time Division Duplex (TDD), a Universal Mobile Telecommunication System (UMTS), a Worldwide Interoperability for Microwave Access (WiMAX) communication system or a 5G new radio (NR) and so on. In detail, the technical solutions in the embodiments of the present disclosure may be applied to eMBB services under the Option 7a architecture or ultra reliable low latency communications (URLLC).

According to a first aspect, embodiments of the present disclosure provide a control method for displaying a service identifier in an electronic device. The electronic device supports a dual connection mode in which the electronic device establishes a first communication connection with a first network device and establishes a second communication connection with a second network device. The method may include operations of: sending a query request for resource allocation information to the first network device, in response to the electronic device being detected to be in a downlink data service scenario; receiving the resource allocation information from the first network device; and determining and displaying a target service identifier of the electronic device based on the resource allocation information.

In some embodiments, the resource allocation information includes a first network resource block of the second network device. The determining and displaying a target service identifier of the electronic device based on the resource allocation information, includes: determining a channel quality indicator of the second network device, in response to the first network resource block being less than a first threshold; determining the target service identifier as a first service identifier and displaying the first service identifier on a display interface of the electronic device, in response to the channel quality indicator being less than a second threshold; and determining the target service identifier as a first service identifier and displaying the second service identifier on the display interface of the electronic device, in response to the channel quality indicator being greater than the second threshold.

In some embodiments, the determining a channel quality indicator of the second network device includes: acquiring a channel parameter and signal strength of the second network device; and determining the channel quality indicator of the second network device based on the channel parameter and the signal strength.

In some embodiments, the first service identifier is a 4G icon indicating transmission form of service data in 4G network, and the second service identifier is a 5G icon indicating transmission form of service data in 5G network.

In some embodiments, the channel parameter includes at least one of: a transmission rate, a signal-to-noise ratio, channel gain, and a noise power.

In some embodiments, the first network resource block is sent from the second network device to the first network device, in response to the query request being forwarded from the first network device to the second network device.

In some embodiments, the resource allocation information includes a first available downlink bandwidth of the first network device and a second available downlink bandwidth of the second network device. The determining and displaying a target service identifier of the electronic device based on the resource allocation information, includes: determining the target service identifier as a first service identifier and displaying the first service identifier on a display interface of the electronic device, in response to the first available downlink bandwidth being greater than the second available downlink bandwidth; and determining the target service identifier as a second service identifier and displaying the second service identifier on the display interface of the electronic device, in response to the first available downlink bandwidth being less than the second available downlink bandwidth. The first service identifier and the second service identifier indicate transmission form of service data in different network architectures.

In some embodiments, the first service identifier is a 4G icon indicating transmission form of service data in 4G network, and the second service identifier is a 5G icon indicating transmission form of service data in 5G network.

In some embodiments, the second available downlink bandwidth is sent from the second network device to the first network device, in response to the query request is forwarded from the first network device to the second network device.

In some embodiments, the resource allocation information includes at least one of: a network resource block, a file size, and an available downlink bandwidth.

In some embodiments, prior to the sending a query request for resource allocation information to the first network device, the method further includes: performing a switch-on registration process in response to a switch-on event, receiving network description information of the 5G NSA network sent from the first network device, wherein the network description information includes at least a type and a capability of the NGC network; and determining a set of service identifiers of the electronic device based on the network description information, the set of service identifiers includes the target service identifier.

In some embodiments, each of the first network device and the second network device is a network device in a 5G non-standalone (NSA) network; the first network device is a 4G base station; the second network device is a 5G base station; a core network of the 5G NSA network is a next-generation core network (NGC); the first network device is in a communication connection with the second network device; and the first network device is in a communication connection with the NGC.

According to a second aspect, embodiments of the present disclosure provide an electronic device, supporting a dual connection mode in which the electronic device establishes a first communication connection with a first network device and establishes a second communication connection with a second network device. The electronic device includes a processor, a non-transitory memory, a communication interface, and one or more programs, wherein the one or more programs are stored in the non-transitory memory and are configured to be executed by the processor, and the programs include an instruction for performing operations of: sending a query request for resource allocation information to the first network device, in response to the electronic device being detected to be in a downlink data service scenario; receiving the resource allocation information from the first network device; and determining and displaying a target service identifier of the electronic device based on the resource allocation information.

In some embodiments, the resource allocation information includes a first network resource block of the second network device. While determining and displaying the target service identifier of the electronic device based on the resource allocation information, the programs further include an instruction for performing operations of: determining a channel quality indicator of the second network device, in response to the first network resource block being less than a first threshold; determining the target service identifier as a first service identifier and displaying the first service identifier on a display interface of the electronic device, in response to the channel quality indicator being less than a second threshold; and determining the target service identifier as a first service identifier and displaying the second service identifier on the display interface of the electronic device, in response to the channel quality indicator being greater than the second threshold.

In some embodiments, while determining a channel quality indicator, the programs further include an instruction for performing operations of: acquiring a channel parameter and signal strength of the second network device; and determining the channel quality indicator of the second network device based on the channel parameter and the signal strength.

In some embodiments, the channel parameter includes at least one of: a transmission rate, a signal-to-noise ratio, channel gain, and a noise power.

In some embodiments, the first network resource block is sent from the second network device to the first network device, in response to the query request being forwarded from the first network device to the second network device.

In some embodiments, the resource allocation information includes a first available downlink bandwidth of the first network device and a second available downlink bandwidth of the second network device. While determining and displaying the target service identifier of the electronic device based on the resource allocation information, the programs further include an instruction for performing operations of: determining the target service identifier as a first service identifier and displaying the first service identifier on a display interface of the electronic device, in response to the first available downlink bandwidth being greater than the second available downlink bandwidth; and determining the target service identifier as a second service identifier and displaying the second service identifier on the display interface of the electronic device, in response to the first available downlink bandwidth being less than the second available downlink bandwidth.

In some embodiments, each of the first network device and the second network device is a network device in a 5G non-standalone (NSA) network; the first network device is a 4G base station; the second network device is a 5G base station; a core network of the 5G NSA network is a next-generation core network (NGC); the first network device is in a communication connection with the second network device; and the first network device is in a communication connection with the NGC.

According to a third aspect, non-transitory computer-readable storage medium is provided and is configured to store a computer program for exchanging electronic data. The computer program enables a process or an electronic device to execute operations of: sending a query request for resource allocation information to a first network device, in response to the electronic device being detected to be in a downlink data service scenario, the electronic device supporting a dual connection mode in which the electronic device is capable of establishing a first communication connection with a first network device and is capable of establishing a second communication connection with a second network device; receiving the resource allocation information from the first network device; and determining and displaying a target service identifier of the electronic device based on the resource allocation information.

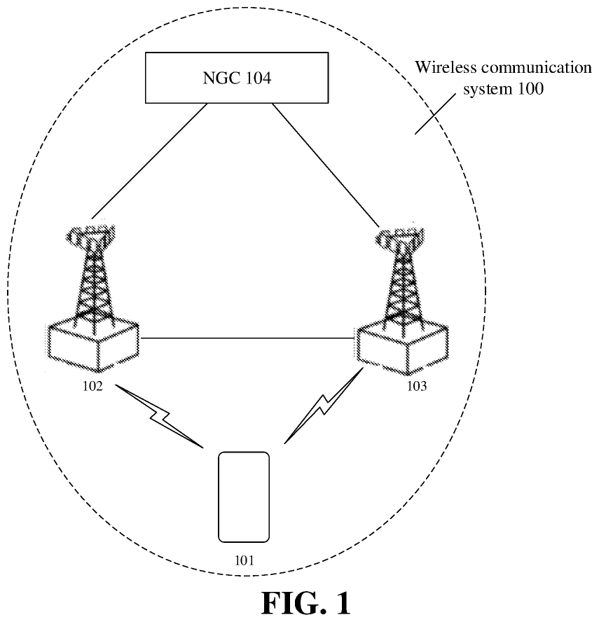

As shown in FIG. 1, FIG. 1 is an exemplary architecture of a wireless communication system 100 provided by an embodiment of the present disclosure. The wireless communication system 100 of the present embodiment may include: an electronic device 101, a 4G base station 102, a 5G base station 103, and a 5G core network device 104. A network accessed by the electronic device 101 may be a 5G non-standalone (NSA) network. A control plane signaling may be transmitted through the base station 102. User plane data of the electronic device may be transmitted to the core network device NGC104 through the base station 102 and the base station 103 respectively. The base station 103 may be communicatively connected to the core network device 104. The core network device NGC104 may support a dual connection mode. The electronic device 101 specifically may maintains a communicative connection with the base station 102 and the base station 103 at the same time in the dual connection mode, and a data transmission service may be achieved through the network. In addition, in the network, the next generation core network (NGC) may replace the evolved packet core (EPC). In this way, a risk of a core network signaling being overloaded may be solved, and the electronic device may achieve voice call services, such as an eMBB service, through the network.

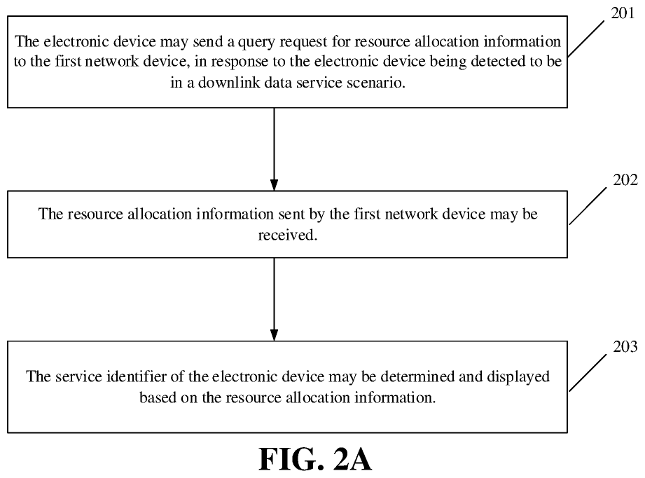

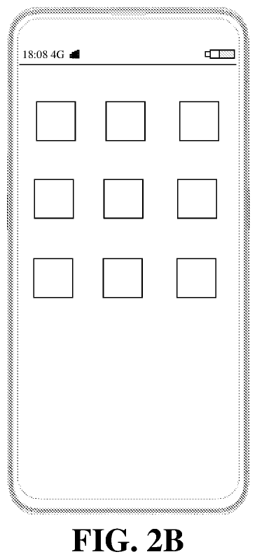

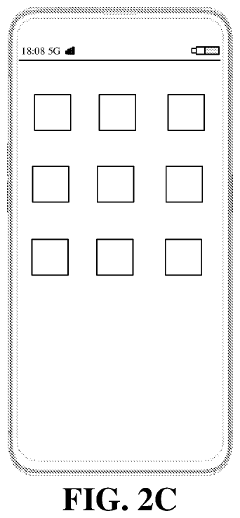

As shown in FIG. 2A, FIG. 2A is a flowchart of a control method for displaying a service identifier in an electronic device according to an embodiment of the present disclosure. The method may be applied in the electronic device shown in FIG. 1. The electronic device may support the eMBB service and the dual connection mode. In the dual connection mode, the electronic device may establish a first communication connection with a first network device and establish a second communication connection with a second network device. Each of the first network device and the second network device may be a network device in a 5G NSA network. The first network device may be a fourth-generation (4G) base station eNB. The second network device may be a 5G base station gNB. A core network of the 5G NSA network may be the NGC. The first network device may be communicatively connected to the second network device, and the first network device may be communicatively connected to the NGC. As shown in FIG. 2A, the control method for displaying the service identifier may include following operations.

In an operation 201, the electronic device may send a query request for resource allocation information to the first network device, in response to the electronic device being detected to be in a downlink data service scenario.

In the present embodiment, the electronic device may detect the service scenario of the electronic device. The electronic device may send the query request for resource allocation information in response to the electronic device being detected to be in the downlink data service scenario. Considering that the control plane signaling may be transmitted through the eLTE base station, the query request for resource allocation information may be sent to the first network device. The downlink data service may refer to the electronic device receiving data sent by the eNB or the gNB.

In an operation 202, the resource allocation information sent by the first network device may be received.

The resource allocation information may include at least one of: a network resource block, a file size, an available downlink bandwidth, etc. In the present embodiment, after receiving the query request for resource allocation information, the first network device may send first resource allocation sub-information corresponding to the first network device to the electronic device. The first resource allocation sub-information may include the file size and the available downlink bandwidth corresponding to the first network device. The first network device may also forward the query request for resource allocation information to the second network device, and receive second resource allocation sub-information sent by the second network device. The second resource allocation sub-information may include a first network resource block of the second network device, a file size of the second network device, and an available downlink bandwidth of the second network device. Subsequently, the first network device may send the second resource allocation sub-information to the electronic device. The first resource allocation sub-information may carry a first device identifier of the first network device, and the second resource allocation sub-information may carry a second device identifier of the second network device. In this way, the electronic device may distinguish the first resource allocation sub-information and the second resource allocation sub-information based on the first device identifier and the second device identifier.

In an operation 203, a target service identifier of the electronic device may be determined based on the resource allocation information, and the target service identifier may be displayed.

The service identifier may be configured to indicate a form of the service data being transmitted under each of various network architectures. For example, in the 4G LTE network, the electronic device may display an icon “VoLTE” on a calling interface in the downlink data service. The identifier “VoLTE” may be configured to indicate that the electronic device may support the downlink data service through the 4G LTE network. In detail, the service data of the downlink data service may be transmitted through the 4G LTE network.

The service identifier may be at least one of: NR, uRLLC, 4G, 5G, etc., which will not be limited herein.

Alternatively, the resource allocation information may include the first network resource block of the second network device. In the operation 203, determining and displaying the target service identifier of the electronic device based on the resource allocation information, may include following operations.

In an operation 31, in response to the first network resource block being less than a first threshold, a channel quality indicator of the second network device may be determined.

In an operation 32, in response to the channel quality indicator being less than a second threshold, the target service identifier may be determined as a first service identifier, and the first service identifier may be displayed on a display interface of the electronic device. In response to the channel quality indicator being greater than the second threshold, the target service identifier may be determined as a second service identifier, and the second service identifier may be displayed on the display interface of the electronic device. The first service identifier and the second service identifier may indicate transmission form of service data in different network architectures.

The electronic device may preset the first threshold for the network resource block and the second threshold for the channel quality indicator. A threshold may refer to a size of the network resource block, for example, the first threshold may refer to a size of a maximal network resource block. For example, the first threshold may be 100, and the second threshold may be 10. After the first network resource block is determined, it may be determined whether the first network resource block is less than the first threshold. In response to the first network resource block being less than the first threshold, the channel quality indicator of the second network device may further be determined.

Alternatively, the above-mentioned first network resource block is sent from the second network device to the first network device, in response to the query request is forwarded from the first network device to the second network device.

Alternatively, determining the channel quality indicator of the second network device may include following operations.

In an operation A1, a channel parameter and signal strength of the second network device may be acquired.

In an operation A2, the channel quality indicator of the second network device may be determined based on the channel parameter and the signal strength.

The channel parameter may include at least one of: a transmission rate, a signal-to-noise ratio, channel gain, and a noise power. In the present embodiment, the channel quality indicator may be determined based on the channel parameter and the signal strength. In response to the channel quality indicator being less than the second threshold, the target service identifier may be determined as the first service identifier, the first service identifier may be displayed on the display interface of the electronic device. In response to the channel quality indicator being greater than the second threshold, the target service identifier may be determined as the second service identifier, and the second service identifier may be displayed on the display interface of the electronic device. The first service identifier and the second service identifier may indicate transmission form of service data in different network architectures.

Alternatively, the first service identifier may be a 4G icon indicating transmission form of service data in 4G network, and the second service identifier may be a 5G icon indicating transmission form of service data in 5G network.

As shown in FIGS. 2B to 2C, FIG. 2B is a presentative view of displaying the first service identifier on the display interface according to an embodiment of the present disclosure. As shown in FIG. 2B, the first service identifier may be the “4G” icon. FIG. 2C is a presentative view of displaying the second service identifier on the display interface according to an embodiment of the present disclosure. As shown in FIG. 2C, the second service identifier may be the “5G” icon.

Alternatively, the resource allocation information may include a first available downlink bandwidth of the first network device and a second available downlink bandwidth of the second network device, and determining the target service identifier of the electronic device based on the resource allocation information may include following operations.

The target service identifier of the electronic device may be determined based on the first available downlink bandwidth and the second available downlink bandwidth.

The electronic device may compare the first available downlink bandwidth with the second available downlink bandwidth after obtaining the first available downlink bandwidth and the second available downlink bandwidth. In response to the first available downlink bandwidth being greater than the second available downlink bandwidth, the target service identifier may be determined as the first service identifier, and the first service identifier may be displayed on the display interface of the electronic device. In response to the first available downlink bandwidth being less than the second available downlink bandwidth, the target service identifier may be determined as the second service identifier, and the second service identifier may be displayed on the display interface of the electronic device. The first service identifier and the second service identifier may indicate transmission form of service data in different network architectures.

In order to display the service identifier on the display interface of the electronic device, a service interface of the downlink data service may be determined firstly, correspondence between a pre-configured service interface and a display position of the service identifier may be enquired, and a target display position corresponding to the service interface of the downlink data service may be determined. Subsequently, the service identifier may be displayed at the target display position. In a specific implementation, a preset display position of the service identifier may be variable for various types of service interfaces. For example, on an interface of a calling state, the service identifier may be displayed at an upper left corner of the interface. In another example, in an application interface of another application, the service identifier may be displayed at an upper middle portion of the interface. In this way, the electronic device may flexibly adjust and adapt the display position of the service identifier on a current service interface for each of various types of service interfaces of the downlink data service, such that the electronic device may have higher flexibility and intelligence for displaying the service identifier.

Alternatively, in the present embodiment, before the electronic device sends the query request for resource allocation information to the first network device, the method further includes: in response to the electronic device detecting a switch-on event, performing a switch-on registration process, receiving network description information of the 5G NSA network sent from the first network device, and determining a set of service identifiers of the electronic device based on the network description information, and the set of service identifiers may include the target service identifier. The network description information may include at least a type and a capability of the NGC network.

A service identifier set may include following identifiers: 4G VoLTE, VoLTE, and VoNR. The 4G VoLTE may be configured to indicate that the downlink data service is supported by an EPC in the 5G NSA system. The VoLTE may be configured to indicate that the downlink data service is supported by the NGC and 4G access network in the 5G NSA system cooperatively (specifically, the data may be transmitted from the 4G access network to the core network NPC, or from a 5G access network to the 4G access network and further to the core network NPC). The VoNR may be configured to indicate that the downlink data service is supported by the NGC in the 5G NSA system.

In a specific implementation, while the electronic device is performing the switch-on registration process, the network side may determine a type of the base station that the electronic device accesses, and a cell at which the electronic device currently resides, i.e. the network side may determine that the network accessed by the electronic device is the 5G NSA network. Subsequently, the network side may send a type and a capability of a core network device of the network to the electronic device. The type may include EPC and/or NGC, and the capability may include whether an IMS voice service is supported. In addition, the service identifier set may include correspondence between the network description information and the service identifier of the downlink data service. In this way, the electronic device may complete configuration of the service identifier of the downlink data service quickly during the switch-on registration process. In this way, in a subsequent process of enabling the downlink data service, in response to an accessed service operator remaining unchanged, the service identifier may be displayed based on the pre-configured service identifier directly, so as to improve an efficiency and accuracy of the electronic device displaying the service identifier.

It may be seen that, in the present embodiment, in response to the electronic device being detected to be in the downlink data service scenario, the electronic device may send the query request for resource allocation information to the first network device, receive the resource allocation information sent by the first network device, determine and display the target service identifier of the electronic device based on the resource allocation information. In this way, as the electronic device is maintained in the dual connection mode, the form for transmitting the service data may be selected flexibly based on the resource allocation information of the network device, such that the efficiency and stability of data transmission may be improved, and the actual communication status of the electronic device may be displayed accurately, intuitively and comprehensively, improving comprehensiveness and accuracy of the electronic device displaying information.

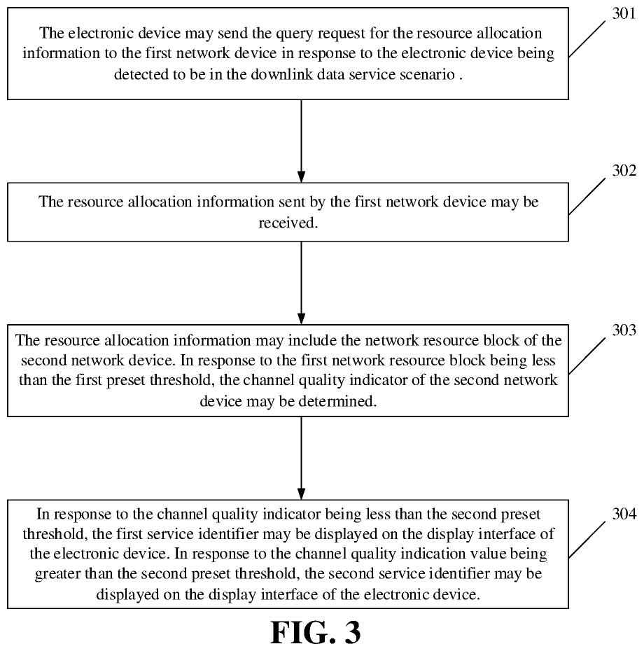

In conformity with the embodiment shown in FIG. 2A, as shown in FIG. 3, FIG. 3 is a flowchart of a control method for displaying a service identifier in an electronic device according to an embodiment of the present disclosure. The method may be applied in the electronic device shown in FIG. 1. The electronic device may support the eMBB service and the dual connection mode. In the dual connection mode, the electronic device may establish a first communication connection with a first network device and establish a second communication connection with a second network device. Each of the first network device and the second network device may be a network device in a 5G NSA network. The first network device may be a fourth-generation (4G) base station eNB. The second network device may be a 5G base station gNB. A core network of the 5G NSA network may be the NGC. The first network device may be communicatively connected to the second network device, and the first network device may be communicatively connected to the NGC. As shown in FIG. 3, the present control method for displaying the service identifier may include following operations.

In an operation 301, in response to the electronic device being detected to be in the downlink data service scenario, the electronic device may send the query request for resource allocation information to the first network device.

In an operation 302, the resource allocation information sent by the first network device may be received.

In an operation 303, the resource allocation information may include the first network resource block of the second network device. In response to the first network resource block being less than the first threshold, the channel quality indicator of the second network device may be determined.

In an operation 304, in response to the channel quality indicator being less than the second threshold, the target service identifier may be determined as the first service identifier, and the first service identifier may be displayed on the display interface of the electronic device. In response to the channel quality indicator being greater than the second threshold, the target service identifier may be determined as the second service identifier, and the second service identifier may be displayed on the display interface of the electronic device. The first service identifier and the second service identifier may indicate transmission form of service data in different network architectures.

It may be seen that, in the present embodiment, in response to the electronic device being detected to be in the downlink data service scenario, the electronic device may send the query request for resource allocation information to the first network device, and receive the resource allocation information sent by the first network device. The resource allocation information may include the first network resource block of the second network device. In response to the first network resource block being less than the first threshold, the electronic device may determine the channel quality indicator of the second network device. In response to the channel quality indicator being less than the second threshold, the target service identifier may be determined as the first service identifier, and the first service identifier may be displayed on the display interface of the electronic device. In response to the channel quality indicator being greater than the second threshold, the target service identifier may be determined as the second service identifier, and the second service identifier may be displayed on the display interface of the electronic device. The first service identifier and the second service identifier may indicate transmission form of service data in different network architectures. In this way, as the electronic device maintains the dual connection mode, the form for transmitting the service data may be selected flexibly based on the resource allocation information of the network device, the efficiency and stability of data transmission may be improved, and the actual communication status of the electronic device may be displayed accurately, intuitively and comprehensively, such that comprehensiveness and accuracy of the electronic device displaying information may be improved.

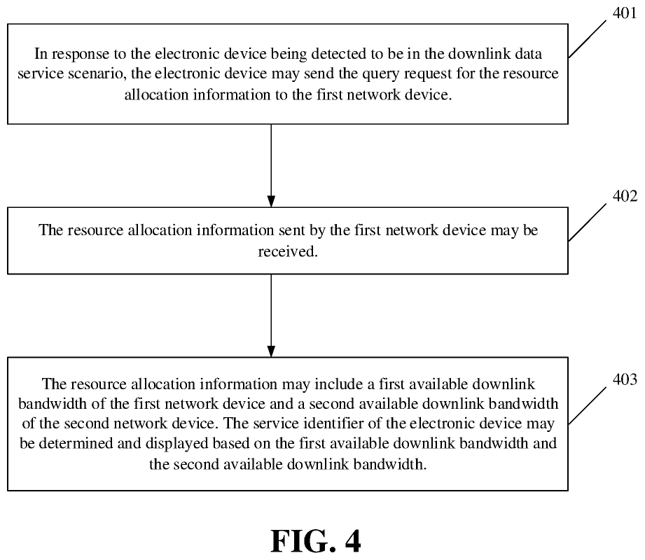

In conformity with the embodiment shown in FIG. 2A, as shown in FIG. 4, FIG. 4 is a flowchart of a control method for displaying a service identifier according to an embodiment of the present disclosure. The method may be applied in the electronic device. The electronic device may support the eMBB service and the dual connection mode. In the dual connection mode, the electronic device may establish a first communication connection with a first network device and establish a second communication connection with a second network device. Each of the first network device and the second network device may be a network device in a 5G NSA network. The first network device may be a fourth-generation (4G) base station eNB. The second network device may be a 5G base station gNB. A core network of the 5G NSA network may be the NGC. The first network device may be communicatively connected to the second network device, and the first network device may be communicatively connected to the NGC. As shown in FIG. 4, the control method for displaying the service identifier may include following operations.

In an operation 401, in response to the electronic device being detected to be in the downlink data service scenario, the electronic device may send the query request for resource allocation information to the first network device.

In an operation 402, the resource allocation information sent by the first network device may be received.

In an operation 403, the resource allocation information may include the first available downlink bandwidth of the first network device and the second available downlink bandwidth of the second network device. The target service identifier of the electronic device may be determined and displayed based on the first available downlink bandwidth and the second available downlink bandwidth.

It can be seen that, in the present embodiment, in response to the electronic device being detected to be in the downlink data service scenario, the electronic device may send the query request for resource allocation information to the first network device, and receive the resource allocation information sent by the first network device. The resource allocation information may include the first available downlink bandwidth of the first network device and the second available downlink bandwidth of the second network device. The electronic device may determine and display the target service identifier of the electronic device based on the first available downlink bandwidth and the second available downlink bandwidth. In this way, the electronic device maintains the dual connection mode, and therefore, the electronic device may flexibly select the form for transmitting the service data based on the resource allocation information of the network device, improving the efficiency and stability of data transmission, and the actual communication status of the electronic device may be shown accurately, intuitively and comprehensively, improving the comprehensiveness and accuracy of information displayed by electronic device.

In addition, as the electronic device maintains the dual connection mode, the electronic device may flexibly select the form for transmitting service data based on the channel quality, thereby improving the efficiency and stability of data transmission.

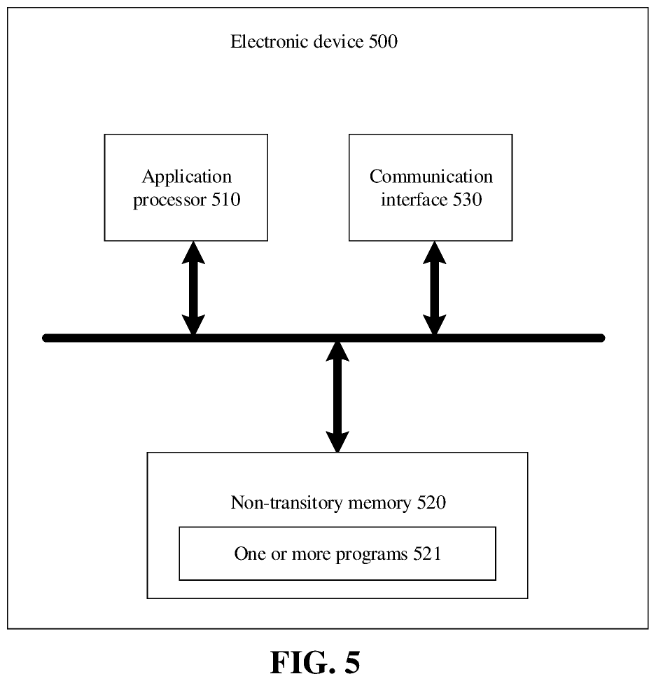

In conformity with the embodiments shown in FIGS. 2A, 3, and 4, as shown in FIG. 5, FIG. 5 is a structural schematic view of an electronic device according to an embodiment of the present disclosure. As shown in the figure, the embodiment may be applied in the electronic device 500. The electronic device may support the eMBB service and the dual connection mode. In the dual connection mode, the electronic device may establish a first communication connection with a first network device and establish a second communication connection with a second network device. Each of the first network device and the second network device may be a network device in a 5G NSA network. The first network device may be a fourth-generation (4G) base station eNB. The second network device may be a 5G base station gNB. A core network of the

5G NSA network may be the NGC. The first network device may be communicatively connected to the second network device, and the first network device may be communicatively connected to the NGC. The electronic device 500 may include an application processor 510, a non-transitory memory 520, a communication interface 530, and one or more programs 521. The one or more programs 521 may be stored in the non-transitory memory 520 and may be configured to be processed by the application processor 510. The one or more programs 521 may include instructions for performing following operations.

In response to the electronic device being detected to be in the downlink data service scenario, the electronic device may send the query request for resource allocation information to the first network device.

The resource allocation information sent by the first network device may be received.

The target service identifier of the electronic device may be determined based on the resource allocation information, and the target service identifier may be displayed.

It may be seen that, in the present embodiment, in response to the electronic device being detected to be in the downlink data service scenario, the electronic device may send the query request for resource allocation information to the first network device, receive the resource allocation information sent by the first network device, determine the target service identifier of the electronic device based on the resource allocation information, and display the target service identifier. In the downlink data service scenario, the electronic device may select the corresponding service identifier based on the resource allocation information of the network device of the access network, such as displaying the 4G icon or the 5G icon, such that the actual data status of the electronic device in the service process may be displayed accurately, intuitively and comprehensively, improving the comprehensiveness and accuracy of information displayed by the electronic device.

In one embodiment, while determining and displaying the target service identifier of the electronic device based on the resource allocation information, the programs may include instructions for performing following operations.

In response to the first network resource block being less than the first threshold, the channel quality indicator of the second network device may be determined.

In response to the channel quality indicator being less than the second threshold, the target service identifier may be determined as the first service identifier, and the first service identifier may be displayed on the display interface of the electronic device. In response to the channel quality indicator being greater than the second threshold, the target service identifier may be determined as the second service identifier, and the second service identifier may be displayed on the display interface of the electronic device. The first service identifier and the second service identifier may indicate transmission form of service data in different network architectures.

In one embodiment, while determining the channel quality indicator of the second network device, instructions in the programs may be configured to perform following operations. The channel parameter and signal strength of the second network device may be acquired.

The channel quality indicator of the second network device may be determined based on the channel parameter and the signal strength.

In one embodiment, the first service identifier may be the 4G icon indicating transmission form of service data in 4G network, and the second service identifier may be the 5G icon indicating transmission form of service data in 5G network.

In one embodiment, the channel parameter may include at least one of: the transmission rate, the signal-to-noise ratio, the channel gain, and the noise power.

In one embodiment, the first network resource block is sent from the second network device to the first network device, in response to the query request is forwarded from the first network device to the second network device.

In one embodiment, the resource allocation information may include the first available downlink bandwidth of the first network device and the second available downlink bandwidth of the second network device. While determining the target service identifier of the electronic device based on the resource allocation information, the program may include instructions for performing operations of: determining the target service identifier of the electronic device based on the first available downlink bandwidth and the second available downlink bandwidth.

In one embodiment, before sending query request for resource allocation information to the first network device, a processing unit may further be configured to perform following operations. The switch-on registration process may be executed in response to the switch-on event being detected.

The network description information of the 5G NSA network sent from the first network device may be received, and the network description information may include at least the type and the capability of the NGC network.

The target service identifier of the electronic device may be determined based on the network description information.

The above description mainly introduces the technical solution of the embodiments of the present disclosure from the perspective of an execution process of the method. It should be understood that in order to implement the above-mentioned functions, the electronic device may include corresponding hardware structures and/or software modules for performing each function. Those skilled in the art should easily realize that in combination with the exemplary units and algorithm operations in the embodiments provided herein, the present disclosure may be implemented in the form of hardware or a combination of hardware and computer software. Whether a certain function is achieved by hardware or by computer software-driven hardware may be determined depending on a specific application and a design constraint of the technical solution. Professionals may use different methods for each specific application to implement the described functions, but such implementation should not be considered beyond the scope of the present disclosure.

The embodiments of the present disclosure may divide the electronic device into functional units based on the above-mentioned examples of the method. For example, the electronic device may be divided to obtain each functional unit corresponding to each function, or two or more functions may be integrated into one processing unit. The above-mentioned integrated unit may be achieved in the form of hardware or software functional unit. It should be noted that the division into units in the embodiments of the present disclosure is exemplary, and is only a type of logical function division. There may be other division methods in actual implementations.

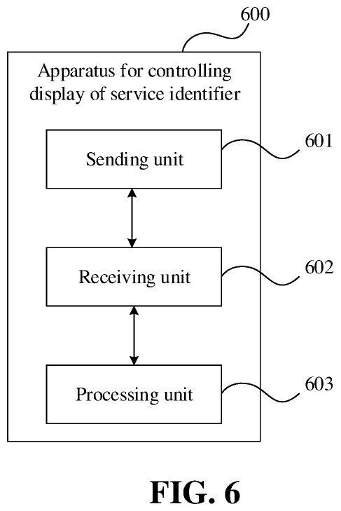

FIG. 6 is a block diagram of the functional unit composition of an apparatus 600 for controlling the display of the service identifier involved in the embodiments of the present disclosure. The apparatus 600 for controlling the display of the service identifier may be applied in an electronic device. The electronic device may support the eMBB service and the dual connection mode. In the dual connection mode, the electronic device may establish a first communication connection with a first network device and establish a second communication connection with a second network device. Each of the first network device and the second network device may be a network device in a 5G NSA network. The first network device may be a fourth-generation (4G) base station eNB. The second network device may be a 5G base station gNB. A core network of the 5G NSA network may be the NGC. The first network device may be communicatively connected to the second network device, and the first network device may be communicatively connected to the NGC. The apparatus 600 for controlling the display of the service identifier may include a sending unit 601, a receiving unit 602, and a processing unit 603.

The sending unit 601 may be configured to send the query request for resource allocation information to the first network device in response to the electronic device being detected to be in the downlink data service scenario.

The receiving unit 602 may be configured to receive the resource allocation information sent by the first network device.

The processing unit 603 may be configured to determine and display the target service identifier of the electronic device based on the resource allocation information.

It may be seen that, in the present embodiment, in response to the electronic device being detected to be in the downlink data service scenario, the electronic device may send the query request for resource allocation information to the first network device, receive the resource allocation information sent by the first network device, determine and display the target service identifier of the electronic device based on the resource allocation information. In the downlink data service scenario, the electronic device may select the corresponding service identifier based on the resource allocation information of the network device of the access network, such as displaying the 4G icon or the 5G icon, such that the actual data status of the electronic device in the service process may be displayed accurately, intuitively and comprehensively, improving the comprehensiveness and accuracy of information displayed by the electronic device.

In one embodiment, the resource allocation information may include the first network resource block of the second network device. While determining and displaying the target service identifier of the electronic device based on the resource allocation information, the processing unit 603 may specifically be configured to perform following operations.

In response to the first network resource block being less than the first threshold, the channel quality indicator of the second network device may be determined.

In response to the channel quality indicator being less than the second threshold, the target service identifier may be determined as the first service identifier, and the first service identifier may be displayed on the display interface of the electronic device. In response to the channel quality indicator being greater than the second threshold, the target service identifier may be determined as the second service identifier, and the second service identifier may be displayed on the display interface of the electronic device. The first service identifier and the second service identifier may indicate transmission form of service data in different network architectures.

In one embodiment, while determining the channel quality indicator of the second network device, the processing unit 603 may specifically be configured to perform following operations.

The channel parameter and the signal strength of the second network device may be acquired.

The channel quality indicator of the second network device may be determined based on the channel parameter and the signal strength.

In one embodiment, the first service identifier may be the 4G icon indicating transmission form of service data in 4G network, and the second service identifier may be the 5G icon indicating transmission form of service data in 5G network.

In one embodiment, the first network resource block is sent from the second network device to the first network device, in response to the query request is forwarded from the first network device to the second network device.

In one embodiment, the resource allocation information may include the first available downlink bandwidth of the first network device and the second available downlink bandwidth of the second network device. While determining the target service identifier of the electronic device based on the resource allocation information, the processing unit 603 may specifically be configured to: determine target the service identifier of the electronic device based on the first available downlink bandwidth and the second available downlink bandwidth.

The embodiments of the present disclosure may further provide a non-transitory computer storage medium. The non-transitory computer storage medium may store a computer program for exchange electronic data. The computer program enables a computer to execute a part or all of the operations of any method as described in the above method embodiments, and the computer may include an electronic device.

The embodiments of the present disclosure also provide a computer program product. The computer program product may include a non-transitory computer-readable storage medium storing a computer program. The computer program is operable to enable a computer to execute a part or all of the operations of any method as described in the above method embodiments. The computer program product may be a software installation package, and the computer may include an electronic product.

It should be illustrated that, in order to provide a concise description for the foregoing method embodiments, the embodiments are all expressed as a series of action combinations, but those skilled in the art should know that the present disclosure is not limited by the described sequence of actions, because according to the present disclosure, some operations may be performed in another order or simultaneously. Further, those skilled in the art should also be aware that the embodiments described in the specification are all preferred embodiments, and the involved actions and modules may not be necessary for the present disclosure.

In the above embodiments, the description of each embodiment has its own emphasis. Parts that are not described in detail in one embodiment may refer to related descriptions in other embodiments.

In the embodiments provided in the present disclosure, it should be understood that the disclosed apparatus may be implemented by other means. For example, the apparatus embodiments described above are merely illustrative. For example, the above-mentioned division of the units is only a type of logical function division, and there may be other types of division in actual implementation, for example, multiple units or components may be combined or integrated into another system, or some features may be omitted or not implemented. Further, the described or discussed mutual coupling or direct coupling or communicative connection may be achieved through some interfaces, indirect coupling or communicative connection. The connection and coupling of devices or units may be in electrical or other forms.

The units described above as separate components may or may not be physically separated, and the components displayed as units may or may not be physical units. That is, they may be located in one place, or they may be distributed on multiple network units. Some or all of the units may be selected according to actual needs to achieve the objectives of the solutions of the embodiments.

In addition, various functional units in the various embodiments of the present disclosure may be integrated into one processing unit. Alternatively, each unit may exist alone physically. Alternatively, two or more units may be integrated into one unit. The above-mentioned integrated unit may be achieved in the form of hardware or software functional unit.

When the above integrated unit is implemented in the form of a software functional unit and sold or used as an independent product, the unit may be stored in a non-transitory computer readable memory. In this way, the essence of the technical solution of the present disclosure, or the part of the technical solution of the present disclosure that contributes to the art, or all or a part of the technical solution of the present disclosure may be achieved in the form of a software product. The computer software product may be stored in a non-transitory memory and include a number of instructions to enable a computer device (which may be a personal computer, a server, or a network device, etc.) to perform all or a part of the operations of the above-mentioned methods of the various embodiments of the present disclosure. The above-mentioned non-transitory memory may include: a universal serial bus disk, a read-only memory (ROM), a random access memory (RAM), a mobile hard drive, a magnetic disk, or an optical disk and other media that can store program codes.

Those ordinary skilled in the art should understand that all or a part of the operations in the various methods of the embodiments may be completed by a program instructing relevant hardware. The program may be stored in the computer-readable non-transitory memory, and the non-transitory memory may include: a flash disk, the Read-only memory (ROM), the random access memory (RAM), the magnetic disk or the optical disk, etc.

The embodiments of the present disclosure are described in detail, and specific examples are used in the specification to illustrate principles and implementation of the present disclosure. The descriptions of the above embodiments are used to facilitate the understanding of the methods and essential concept of the present disclosure. Based on the concept of the present disclosure, any ordinary skilled in the art may perform modification in the specific implementation and the scope of application. In summary, the content of the specification should not be understood as a limitation to the present disclosure.

What is claimed is:

1. A control method for displaying a service identifier in an electronic device, the electronic device supporting a dual connection mode in which the electronic device is capable of establishing a first communication connection with a first network device, and is capable of establishing a second communication connection with a second network device, the control method comprising:
sending a query request for resource allocation information to the first network device, in response to the electronic device being detected to be in a downlink data service scenario;
receiving the resource allocation information from the first network device; and
determining and displaying a target service identifier of the electronic device based on the resource allocation information.

2. The method according to claim 1, wherein the resource allocation information comprises a first network resource block of the second network device; and
the determining and displaying the target service identifier of the electronic device based on the resource allocation information, comprises:
determining a channel quality indicator of the second network device, in response to the first network resource block being less than a first threshold;
determining the target service identifier as a first service identifier and displaying the first service identifier on a display interface of the electronic device, in response to the channel quality indicator being less than a second threshold; and
determining the target service identifier as a first service identifier and displaying a second service identifier on the display interface of the electronic device, in response to the channel quality indicator being greater than the second threshold.

3. The method according to claim 2, wherein the determining the channel quality indicator of the second network device comprises:
acquiring a channel parameter and signal strength of the second network device; and
determining the channel quality indicator of the second network device based on the channel parameter and the signal strength.

4. The method according to claim 2, wherein the first service identifier is a 4G icon indicating transmission form of service data in 4G network, and the second service identifier is a 5G icon indicating transmission form of service data in 5G network.

5. The method according to claim 3, wherein the channel parameter comprises at least one of: a transmission rate, a signal-to-noise ratio, channel gain, and a noise power.

6. The method according to claim 2, wherein the first network resource block is sent from the second network device to the first network device, in response to the query request being forwarded from the first network device to the second network device.

7. The method according to claim 1, wherein the resource allocation information comprises a first available downlink bandwidth of the first network device and a second available downlink bandwidth of the second network device; and
the determining and displaying the target service identifier of the electronic device based on the resource allocation information, comprises:
determining the target service identifier as a first service identifier and displaying the first service identifier on a display interface of the electronic device, in response to the first available downlink bandwidth being greater than the second available downlink bandwidth; and
determining the target service identifier as a second service identifier and displaying the second service identifier on the display interface of the electronic device, in response to the first available downlink bandwidth being less than the second available downlink bandwidth;
wherein the first service identifier and the second service identifier indicate transmission form of service data in different network architectures.

8. The method according to claim 7, wherein the first service identifier is a 4G icon indicating transmission form of service data in 4G network, and the second service identifier is a 5G icon indicating transmission form of service data in 5G network.

9. The method according to claim 7, wherein the second available downlink bandwidth is sent from the second network device to the first network device, in response to the query request is forwarded from the first network device to the second network device.

10. The method according to claim 1, wherein the resource allocation information comprises at least one of: a network resource block, a file size, or an available downlink bandwidth.

11. The method according to claim 1, further comprising:
prior to the sending the query request for resource allocation information to the first network device:
performing a switch-on registration process in response to a switch-on event, receiving network description information of the 5G NSA network sent from the first network device, wherein the network description information comprises at least a type and a capability of the NGC network; and
determining a set of service identifiers of the electronic device based on the network description information, the set of service identifiers comprises the target service identifier.

12. The method according to claim 1, wherein
each of the first network device and the second network device is a network device in a 5G non-standalone (NSA) network;
the first network device is a 4G base station;
the second network device is a 5G base station;
a core network of the 5G NSA network is a next-generation core network (NGC);
the first network device is in a communication connection with the second network device; and
the first network device is in a communication connection with the NGC.

13. An electronic device, supporting a dual connection mode in which the electronic device is capable of establishing a first communication connection with a first network device and is capable of establishing a second communication connection with a second network device, the electronic device comprising a processor, a non-transitory memory, a communication interface, and one or more programs, wherein the one or more programs are stored in the non-transitory memory and are configured to be executed by the processor, and the programs comprise an instruction for performing operations of:
sending a query request for resource allocation information to the first network device, in response to the electronic device being detected to be in a downlink data service scenario;
receiving the resource allocation information from the first network device; and
determining and displaying a target service identifier of the electronic device based on the resource allocation information.

14. The electronic device according to claim 13, wherein the resource allocation information comprises a first network resource block of the second network device, and
while determining and displaying the target service identifier of the electronic device based on the resource allocation information, the programs further comprise an instruction for performing operations of:
determining a channel quality indicator of the second network device, in response to the first network resource block being less than a first threshold;
determining the target service identifier as a first service identifier and displaying the first service identifier on a display interface of the electronic device, in response to the channel quality indicator being less than a second threshold; and
determining the target service identifier as a first service identifier and displaying the second service identifier on the display interface of the electronic device, in response to the channel quality indicator being greater than the second threshold.

15. The electronic device according to claim 14, wherein while determining the channel quality indicator of the second network device, the programs further comprise an instruction for performing operations of:
acquiring a channel parameter and signal strength of the second network device; and
determining the channel quality indicator of the second network device based on the channel parameter and the signal strength.

16. The electronic device according to claim 15, wherein the channel parameter comprises at least one of: a transmission rate, a signal-to-noise ratio, channel gain, or a noise power.

17. The electronic device according to claim 15, wherein the first network resource block is sent from the second network device to the first network device, in response to the query request being forwarded from the first network device to the second network device.

18. The electronic device according to claim 13, wherein the resource allocation information comprises a first available downlink bandwidth of the first network device and a second available downlink bandwidth of the second network device; and
while determining and displaying the target service identifier of the electronic device based on the resource allocation information, the programs further comprise an instruction for performing operations of:
determining the target service identifier as a first service identifier and displaying the first service identifier on a display interface of the electronic device, in response to the first available downlink bandwidth being greater than the second available downlink bandwidth; and
determining the target service identifier as a second service identifier and displaying the second service identifier on the display interface of the electronic device, in response to the first available downlink bandwidth being less than the second available downlink bandwidth.

19. The electronic device according to claim 13, wherein
each of the first network device and the second network device is a network device in a 5G non-standalone (NSA) network;
the first network device is a 4G base station;
the second network device is a 5G base station;
a core network of the 5G NSA network is a next-generation core network (NGC);
the first network device is in a communication connection with the second network device; and
the first network device is in a communication connection with the NGC.

20. A non-transitory computer-readable storage medium, configured to store a computer program for exchanging electronic data, wherein the computer program enables a processor of an electronic device to execute operations of:
sending a query request for resource allocation information to a first network device, in response to the electronic device being detected to be in a downlink data service scenario, the electronic device supporting a dual connection mode in which the electronic device is capable of establishing a first communication connection with a first network device and is capable of establishing a second communication connection with a second network device;
receiving the resource allocation information from the first network device; and
determining and displaying a target service identifier of the electronic device based on the resource allocation information.
